(19) United States
(12) Patent Application Publication
(10) Pub. No.: US 2010/0183024 A1
(43) Pub. Date: Jul. 22, 2010

(54) SIMPLIFIED RDMA OVER ETHERNET AND FIBRE CHANNEL

(75) Inventor: Somesh Gupta, San Jose, CA (US)

Correspondence Address: Wong Cabello Lutsch Rutherford & Brucculeri LLP, 20333 Tomball Parkway, 6th Floor, Houston, TX, 77070, US

(73) Assignee: Brocade Communications Systems, Inc, San Jose, CA (US)

(21) Appl. No.: 12/690,192

(22) Filed: Jan. 20, 2010

Related U.S. Application Data
(60) Provisional application No. 61/146,218, filed on Jan. 21, 2009.

(51) Int. Cl. H04L 12/02; H04L 1/08; G06F 11/14

(52) U.S. Cl. 370/463; 714/748; 714/E11.113

(57) ABSTRACT

A new transport protocol between the IP layer and the DDP layer for use with RDMA operations. The embodiments all operate on a CEE-compliant layer 2 Ethernet network to allow the new transport protocol to be simplified, providing higher performance and simpler implementation. The new protocol allows a CEE-compliant layer 2 Ethernet network to provide data networking using IP, storage using FCoE, and RDMA using IP and the new transport protocol, without suffering the previous performance penalties in any of these aspects.

### CROSS REFERENCE TO RELATED APPLICATIONS

This application claims the benefit under 35 U.S.C. §119(e) of U.S. Provisional Patent Application Ser. No. 61/146,218, entitled “Protocols and Partitioning for RDMA over CEE” by Steven Wilson, Scott Kipp and Somesh Gupta, filed Jan. 21, 2009, which is hereby incorporated by reference.

### BACKGROUND OF THE INVENTION

1. Field of the Invention

The invention relates to data transfer between network devices, and more particularly to direct memory access transfers between two network devices.

2. Description of the Related Art

A converged network would support the following four broad classes of traffic:

1) Data networking also known as IP (TCP/IP) networking,

2) Storage,

3) High-performance computing/clustering (HPC) and

4) Management (especially sideband management traffic)

HPC traffic is dependent heavily on the application and the manner in which parallelism has been extracted from the application. On one end is the need for very low latency, small message communication. At the same time, different nodes running a parallelized application may exchange fairly large amounts of data (Oracle RACK, Luster file system, etc.).

The data exchanges may be, at least partially, addressed by RDMA (Remote Direct Memory Access) in which one end of an application can cause a large amount of data to be moved to/from its memory to its remote peer with low CPU utilization.

The high-end of the HPC market is seeing increasing penetration by InfiniBand which offers low-latency, RDMA, and high bandwidth. But the use of InfiniBand is opposite the trend to a converged network based on a single underlying layer 2 transport such as Ethernet.

The iWARP (Internet Wide Area RDMA Protocol) protocol suite provides support for RDMA over a layer 2 Ethernet environment and is layered on top of the TCP protocol. However, it is a fairly heavyweight protocol since TCP is designed to run over lossy networks, with long round-trip delays and significant bookkeeping and the like. Thus iWARP is not a satisfactory solution due to cost and performance issues.

The development of Converged Enhanced Ethernet (CEE) has brought new capabilities to Ethernet in the data center, particularly the development of Fibre Channel over Ethernet (FCoE) to address the storage requirement, instead of iSCSI over TCP. iSCSI has similar drawbacks as iWARP due to the inclusion of TCP. FCoE provides a high performance protocol over a layer 2 Ethernet network, so that a CEE network can readily provide data networking using IP and storage using FCoE but a satisfactory solution is still needed for RDMA support for HPC environments.

iWARP RDMA is based on two elements. First is a suite of layered protocols specified by the IETF that enable one application end-point to safely read and write memory of another end-point, with no application interaction during the data transfer phase. The suite of protocols consist of RDMAP (RDMA Protocol) and Direct Data Placement (DDP) at the application layer. These are layered on top of different transports. The transport layer is either a combination of MPA (Marker PDU Aligned) layered on top of TCP; or SCTP (Stream Control Transmission Protocol) by itself Second is a service access model that provides a virtual network interface to applications. This model is specified in the RDMA Consortium's RNIC (RDMA Network Interface Controller) Verbs specification, and provides a safe, connection oriented, virtual network interface that can be used by applications directly from user space.

As mentioned earlier, there are two alternatives for the transport layer of iWARP. The most common layering is combination of TCP and MPA. The MPA layer provides a “framing” mechanism on top of TCP, i.e., changes TCP from a byte-stream oriented protocol to a “packetized” or “framing” protocol. There is another alternative for the transport layer and that is to use SCTP. However, there seem to be no commercial implementations of SCTP.

Above the transport is the DDP layer which provides a generic mechanism for sending tagged (direct placement) and untagged messages from the sender to the receiver. In addition, the DDP layer specifies memory protection semantics. The RDMAP layer on top of the DDP layer adds the specific capabilities required to support the RNIC Verbs, such as RDMA Read, RDMA Write, Send, Send with Invalidate, etc.

The service interface provided by the RDMAP forms an integral component of iWARP/RDMA. This is sometimes called RNIC API or Verbs. Multiple protocols can use the Verbs to provide richer services such as iSCSI over RDMA (iSER); NFS over RDMA; MPI, which is a very common middleware for clustering; Sockets Direct Protocol (SDP) to provide sockets like API; Oracle Reliable Datagram Service (RDS) for Oracle's RACK cluster database product; etc.

The iWARP protocol layers are a modified TCP implementation, an MPA layer, a DDP layer and an RDMAP layer. The TCP implementation is expected to be modified for iWARP. The modifications are to allow for Upper Layer Protocol Data Units (ULPDUs) to be aligned with TCP segment boundaries. In a traditional TCP implementation, typically the alignment between Upper Layer PDUs and TCP headers is not maintained. The other modification is to allow TCP to pass in an incoming out-of-order Upper Layer PDU to the MPA layer, something a traditional TCP implementation will not do. These modifications together are intended to convert TCP from a byte-stream oriented protocol to a “reliable” data-gram type protocol, without changing the wire-protocol of TCP.

The MPA Layer adds a protocol header and marker. The purpose is two-fold. One is to provide a framing mechanism for iWARP. This is accomplished through the definition of a header for an iWARP frame (called the Framing PDU) and a trailer CRC. The other purpose is to provide for recovery of the Framing PDU (FPDU) header when TCP segments are received out-of-order. This is accomplished by insertion of a periodic marker in the TCP byte stream. The MPA fields include the ULPDU Length field, which indicates the length of the Framing PDUs; a CRC which starts on the next 4-byte boundary after the FPDU; and a number of PAD bytes, which are implicit depending on the length of the FPDU. Markers occur at periodic interval of 512 bytes—but this does not imply that marker location can be determine by a fixed arithmetic on the TCP sequence number. The starting TCP sequence number for markers is different for different connections. In other words, to locate a marker for a TCP connection, the connection context must be located to determine the starting sequence number for the marker.

The DDP layer uses the DDP header. Its purpose is to transmit tagged and untagged messages from the sender to the receiver. Key features are listed here.

1) Message Identification, segmentation and reassembly of Untagged Messages: Untagged Messages are not “Direct Placement” messages. The DDP protocol provides a Message Sequence number and a Queue Number to identify a message within a connection stream. The Sequencing information allows a message to be segmented and reassembled.

2) Tagged Messages for Direct Placement: These messages are for direct placement to a location at the sink defined by the Stag (scatter-gather list handle) and an offset within that list.

3) The untagged messages are “delivered” to the remote consumer whereas the tagged messages are not delivered to the remote consumer. In other words, the tagged messages are consumed within the RNIC.

4) The DDP Layer depends on the underlying transport to provide reliable delivery of messages. Out of order messages can be provided for placement, but delivery is in order.

5) DDP Messages are within the context of a stream or a connection. This feature is provided by the underlying transport layer.

6) The DDP layer requires that the Stag on which the operation is performed be valid for the stream on which the data transfer is taking place. It also requires offset checks.

The RDMA protocol layer further refines the DDP layer to provide the defined RNIC interface.

1) The DDP untagged message with Queue Number 0 supports 4 different variations of the ability to send a message from the source to the destination
a) Send
b) Send with Invalidate (invalidate the Stag when the Send message is delivered)
c) Send with Solicited Event (notify the receiver application that a message has arrived)
d) Send with Solicited Event and Invalidate

2) The DDP untagged message with Queue Number 1 supports sending an RDMA read request message to the remote side (data source). It is assumed that the RNIC on the remote end can properly follow all the rules, and return the read data without informing the consumer.

3) The DDP untagged message with Queue Number 2 supports sending an error message

4) The DDP tagged message can be of two different types
a) RDMA Write
b) RDMA Read response
c) The messages are distinguished by the RDMA Opcode

5) RDMA headers are defined only for the RDMA Read Request and Error messages.

6) The RDMA protocol layer further clarifies the protection and ordering semantics associated with RDMA.

The iWARP protocol suite makes a significant distinction between placement and delivery. Placement of an inbound DDP Segment is allowed as long as the segment can be cleanly delineated and meets other rules.

1) Delineation implies that alignment is maintained at the sender and through middle-boxes. Delineation is recovered by confirming markers and CRC in the context of the TCP sequence number

2) Rules means it passes all of the protocol validation rules and all access control rules

But messages can be delivered only in order. This implies that a complete RNIC implementation has to track “meta-data” at the message-level in case of out of order packets. This imposes a significant complexity on a conformant implementation. Some examples are given below, but it is not a complete list.

1) If there is an Send with Invalidate or Send with Solicited Event and an Invalidate message is received out of order, the invalidation component cannot be acted on until the missing segments are received. This is because if a Stag is invalidated, and the missing segment targeted that Stag, it will encounter a “false” protection fault.

2) The same discussion applies to RDMA Read Requests. If an RDMA Read Request is received, processing of the request must not start while the stream has missing segments. The missing segments could have an impact on data returned with the Read Request or the validity of the Read Request itself

3) RDMA Read responses also have an impact on ordering. A user making an RDMA Read Request can specify invalidation of the local Stag after the completion of the RDMA Read Request.

It is important to note from the above discussion that the issues are not simply around implementing a TCP offload engine (TOE). There are complexities in the iWARP specification that complicate its implementation. These are further factors limiting the success and usefulness of iWARP.

Following are some of the features of the RNIC Interface. The RDMA Verbs specification allows for direct user space access to the RNIC for sending and receiving untagged messages, and RDMA Read and Write operations; without going through the operating system kernel. In other words, user space applications have access to a Virtual Interface.

1) Protection and Isolation of host memory as well as RNIC resources is critical to the concept of user space access
a) The model accommodates multiple applications that do not trust each other or may actively attempt to interfere with each other, such as in the case of a classic large multi-user system.
b) The model accommodates an application communicating with multiple remote points (multiple connections), and the remote points are hostile, i.e., may attempt to attack the system or each other, such as in a classic web server model.

To achieve protection and isolation along with direct user space access, the life-cycle of resources such as Queues, Protection Domains, and Memory Handles/Stags is managed by a kernel mode driver.

All communication happens on a bidirectional stream. The simplest mapping of that is to a TCP connection, or any other mechanism offered by the underlying transport. The implication of this is that, whether in software or in hardware, there is the concept of a “stream context” or a “connection context”.

A queue pair is tied one-to-one with a stream.

1) The Send Queue of the pair is used for sending commands to the RNIC. These commands include Send commands that transfer data from the local system to the remote end point of the connection, RDMA commands that can be either RDMA Read or RDMA Write commands, commands that invalidate Stags, and commands that associate a Memory Window with a memory region.

2) The Receive Queue is used to provide Receive Buffers for inbound data (Send data from the remote node perspective). The inbound Receive Buffers are expected to be consumed in order, i.e., the buffers are expected to be consumed in a one-to-one relationship with the Message Sequence Number in the untagged DDP messages.

There is very flexible mapping between Completion Queues and Send and Receive Queues from different connections.

Instead of each connection having its own receive queues, shared receive queues can be shared among multiple connections. Shared Receive Queues do not have the same ordering constraints as Receive Queues. A RNIC is allowed to limit the number of Completion Queues and Shared Receive Queues it supports.

All Queue Pairs/Connections and Stags/Memory Regions are associated with Protection Domains. Operations are allowed on an Stag/Memory Region only when the Protection Domains of the memory region and the queue pair are identical. This is however not a sufficient condition for the operation to be allowed. Explicit permissions for the operation being performed must match as well.

Fundamental to achieving protection and isolation, while at the same time allowing a remote end-point to read and write memory on the system, is the concept of Stags—which are “RDMA Memory Handles”. The concept is similar to how the virtual to physical memory mapping on a system provides protection and isolation among user space applications on a system.

1) The remote end-point in an RDMA connection is provided Stags for the local end-point for RDMA operations. On the local end-point, the Stags map to a set of physical addresses (a list of pages, a start offset, and a total length).

2) The Stags are associated with specific protection domains, and have specific access rights enabled (local read, local write, remote read, remote write).

3) In general, the creation of Stags, their association with system physical memory, and access rights is performed through the privileged module in kernel space.

4) The RNIC is required to enforce all the access rights when reading from or writing into the memory associated with an Stag (in addition to performing bounds checks, state validity etc.). This ensures that a non-privileged application cannot read from or write into local or remote memory to which it has not been granted appropriate access.

5) A special type of memory region is called a shared memory region. This is a memory region with a Stag like other types of memory regions. However, there are other Stags that refer to the memory associated with this Stag as well. Therefore the same “memory list” or “memory registration” can be used with different Stags, each with their own Protection Domain or access rights.

6) Memory Windows are a special case of Stags. They expose a Window into a memory region. The key here is that association of a memory window and controlling access rights (subset) is performed by an operation on the Send Queue and not through the kernel module. This operation can be performed by a non-privileged application. A non-privileged application would use the kernel interface to create a memory region with the associated memory. It would also use the kernel interface to allocate a memory window Stag. The memory window stag can then be associated with a window into the previously registered memory region through the Send Queue in what is considered a light-weight operation.
a) An allocated memory window can be associated with different memory regions by first invalidating it.
b) As an example, an application could register all its memory using a Stag. It could then allocate a few window Stags and never have to go through the process of calling the kernel module for memory management services. It can associate the memory window stags at different times with different section of the memory region by using the Send Queue to the RNIC for this purpose.
c) Another difference between Memory Windows and Memory Regions is that a valid Memory Window has narrower access control than a Region. A valid memory Window is associated with the specific connection whose send queue was used to create the association between the Window and a memory region. The memory window can be accessed only with operation on that specific connection; till it is invalidated and revalidated on a different connection.

In a traditional I/O model, the driver provides a scatter-gather list to the NIC/HBA (Host Bus Adaptor). Each item/element in the scatter-gather list consists of a host memory physical address and a length. The NIC reads from or writes into the memory described by the scatter-gather list.

1) However in the RDMA model, with direct user space access, each scatter-gather list element uses an Stag and an offset within the Stag, instead of the host memory physical address. This allows the RNIC to ensure that the consumer has permissions to access the memory that it wishes to through a combination of protection domain with which the consumer and Stag are associated, and the indirection from the Stag/offset to the host physical memory.

2) Stag Value of 0: Privileged users are allowed to use an Stag value of 0 in scatter-gather lists only; which means that the offset is the actual host physical address.

There are two operations on the Send Queue that are allowed or disallowed depending on the privilege level of the consumer. One is the use of Stag value of 0 in the scatter-gather lists. The other is the ability to associate an already allocated memory region (not window) Stag with a set of host pages. The two privileges are controlled independently, however it is likely that they will be allowed/disallowed to the same consumers. Having this privilege means that the application can perform memory management operations without having to go through the privileged kernel module.

Fencing an operation implies that the operation will not start until all prior operations that may impact this operation have completed. There are two types of fencing attributes defined, read fence and local fence.

In addition to the ordering requirements imposed by the protocol, additional ordering requirements are imposed by the interface. Work Items must be completed in the order they are posted on the Send Queue and the Receive Queue.

The following are some of the challenges of implementing TCP and MPA in an adapter.

1) TCP is byte-stream oriented whereas DDP requires the transport layer to preserve segment boundaries. This requires the addition of the MPA layer. In addition, it requires buffering for, and detection/handling of, partial PDUs

2) One of the mechanisms used by MPA for frame recovery is markers. Markers are inserted relative to the initial sequence number of the TCP connection, i.e., to detect the location of a marker in a TCP segment, the TCP context is required.

3) MPA marker insertion and deletion itself adds additional requirements. One example is when retransmitting segments when the path MTU has changed.

4) TCP context lookup requires specialized hardware support. This is because the TCP context is identified by a sparsely populated, long 4-tuple<source IP address, destination IP address, source port, destination port) whose size on ipv6 is practically unmanageable. There are two classic ways of doing the lookup. One is the use of Context Addressable Memory (CAM), which is very expensive in terms of silicon size and does not scale easily to the number of connections (64K or more) required for some applications. The other mechanism is to use hash lists, which do not have a deterministic search time.

5) TCP state machine processing creates an inter-dependence between the receive path and the send path. This is due to the “ACK clocking” and window updates of the TCP protocol.

6) TCP processing requires double traversal of the send queue. The first traversal is to send the data, and the second traversal is to be able to signal completion to the host. In theory, whenever a new sequence number is acknowledged by the remote peer, the second queue must be traversed to determine the point to which completions for work requests can be signaled to the host driver.

7) The TCP state machine includes many timers that have to be tracked such as delayed ACK timer, retransmission timer, persist timer, keep-alive timer and 2MSL timer. Even if the TCP context which is fairly large is kept elsewhere, the “data-path” timers for every connection must be accessed relatively frequently by the device. This adds cost in terms of on-chip memory, or attached SRAM, or consumes interconnect bus bandwidth.

8) The standard allows for multiple frames in a single TCP segment. In other words, the upper layer state machine may have to be applied multiple times to the same TCP segment.

9) Out-of-order placement and in-order delivery requires the device to track holes in the TCP byte stream, and track actions that have been deferred and must be performed when the holes are filled. This adds significant complexity in the processing stream, and additional storage requirements.

As mentioned earlier, all of these complexities have been overcome, but add cost and cause performance degradation. Thus a solution to alleviate these complexities while increasing performance and decreasing cost is designable to provide RDMA over Ethernet and allow a fully converged layer 2 network.

The solution should provide reliable delivery, preserve DDP Segment boundaries, provide a strong digest (stronger than TCP checksum) to protect the DDP Segment, indicate path MTU to the DDP layer, be able to carry the length of the DDP Segment, be stream oriented so that a DDP stream maps to a single TCP connection when running over TCP and either have in-order delivery, or have the delivery order exposed to DDP.

### SUMMARY OF THE INVENTION

Embodiments according to the present invention utilize a new transport protocol between the IP layer and the DDP layer. Further, the embodiments all operate on a CEE-compliant layer 2 Ethernet network to allow the new transport protocol to be simplified, providing higher performance and simpler implementation. Thus the use of the new transport protocol allows a CEE-compliant layer 2 Ethernet network to provide data networking using IP, storage using FCoE and RDMA using IP and the new transport protocol, without suffering the previous performance penalties in any of these aspects.

### BRIEF DESCRIPTION OF THE DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a block diagram of a network with interconnected hosts and storage devices according to the present invention.

FIG. 2 is a simplified block diagram of a host of FIG. 1.

FIG. 3 is a simplified block diagram of a storage device of FIG. 1.

FIG. 4 is a diagram indicating a prior art protocol stack and protocol stacks according to the present invention.

FIG. 5 is a diagram of relevant protocol stacks according to the present invention with a Fibre Channel fabric.

FIG. 6 is a diagram of relevant protocol stacks according to the present invention with a CEE network.

FIG. 7 is a diagram illustrating packet formation according to the present invention.

FIG. 8 is a diagram of a header according to the present invention.

FIG. 9 is a ladder diagram according to the present invention.

### DETAILED DESCRIPTION

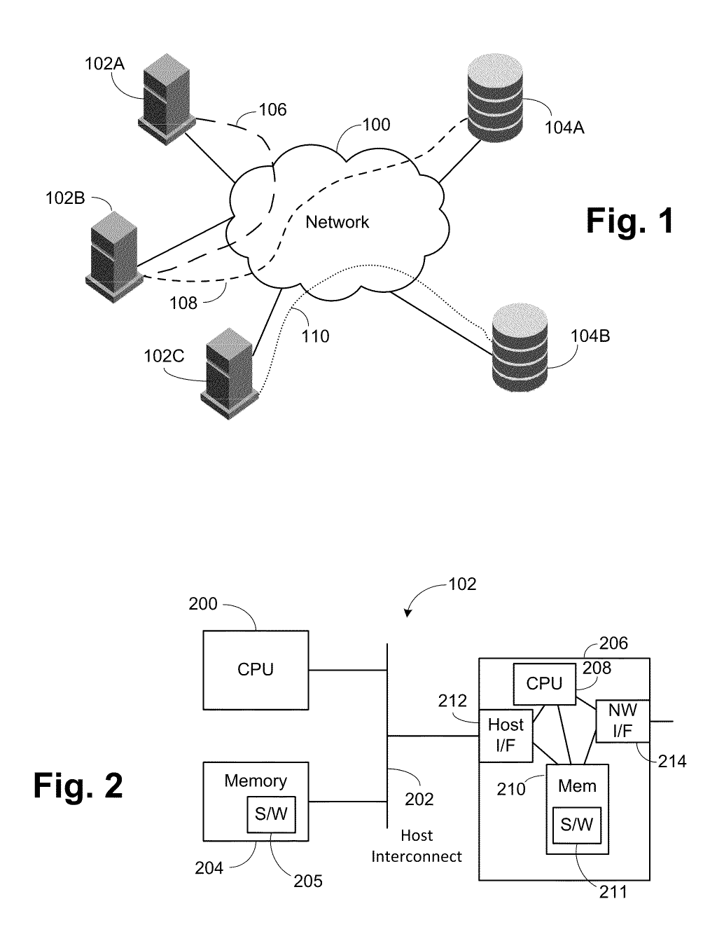

FIG. 1 illustrates a computer system according to the present invention. A network 100 connects a series of workstations or hosts 102 together and to a series of storage unit 104. Each of the hosts 102 and storage units 104 contain memory which is to be accessed directly by the other unit. A channel 106 is present between host 102A and host 102B. A channel 108 is present between host 102B and storage unit 104A. A channel 110 is present between host 102C and storage unit 104B. This is a simplified configuration for illustrating purposes and more complicated configuration can operate according to the present invention.

FIG. 2 illustrates an exemplary host 102. A CPU 200 is connected to an internal host interconnect 202. The host interconnect 202 can be items such as PCI bus, various PCI-e links or various bridge devices, as well known in the industry. The system memory 204 is connected to the host interconnect 202 to allow access by the CPU 200. A network interface card 206 is connected to the host interconnect 202 to allow the host 102 to connect to the network 100. The network interface card 206 includes a CPU 208, card memory 210, a host interface 212 and a network interface 214. The CPU 208 is connected internally to the card memory 210, the host interface 212 and the network interface 214. The card memory 210 is also connected to the host interface 212 and the network interface 214 to allow and aid in RDMA operations. The network interface 214 is connected to a link which connects to the network 100. Both the memory 204 and the card memory 210 include software 205 and 211, respectively, which executes on the respective CPU 200, 208. The network interface 214 will perform portions of the network protocol in hardware in the interface, as appropriate for the particular network protocol.

The CPU 200, CPU 208 and the network interface 214 interact to form an RDMA stack according to the preferred embodiment. Certain layers may be handled in the network interface 214, such as the layer 2 operations, while higher layers are handled by the CPUs 200, 208 using their respective software.

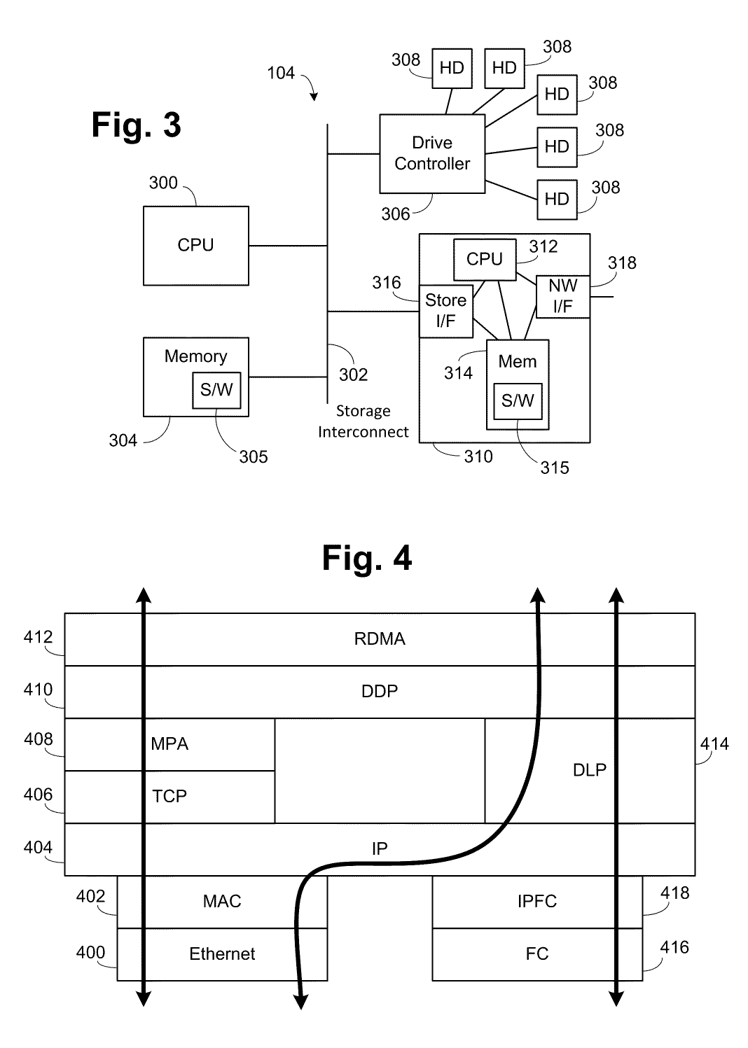

FIG. 3 illustrates an exemplary storage unit 104 according to the present invention. A CPU 300 is connected to a storage interconnect 302. Storage interconnect 302 can be a PCI bus, PCI-e links and the like as noted above. A memory 304 is connected to the storage interconnect 302 to allow access by the CPU 300. A drive controller 306 is connected to the storage interconnect 302 to allow data to be transferred from the CPU 300 and memory 304 through the drive controller 306 to various hard drives 308 which are connected to the drive controller 306. A storage interface card 310 is also connected to the storage interconnect 302. Storage interconnect card 310 includes a CPU 312, memory 314, a storage interface 316 and a network interface 318. The CPU 312 is connected to each of the memory 314, the storage interface 316 and the network interface 318 to control their operations and transfer data. The memory 314 is connected to the storage interface 316 and the network interface 318 to allow RDMA operations as desired. The network interface 318 is connected to a link which then connects to network 100. Both the memory 304 and the card memory 314 include software 305 and 315, respectively, which executes on the respective CPU 300, 312. The network interface 318 will perform portions of the network protocol in hardware in the interface, as appropriate for the particular network protocol.

These are simplified illustrations of host and storage and other configurations can readily be developed and are known to those skilled on the art.

FIG. 4 is a layer diagram indicating the various layers for RDMA operations for both Ethernet and Fibre Channel protocols. The conventional or current map is provided on the left and consists of an Ethernet layer 400, a MAC layer 402, an IP layer 404, a TCP layer 406, an MPA layer 408, a DDP layer 410 and an RDMA layer 412. Thus, as noted in the background, to perform RDMA operations both an IP stack and a TCP stack must be present in the unit.

Shown on the right in FIG. 4 is an alternative path according to the present invention. In the simplest format, the MPA layer 408 and the TCP layer 406 are replaced by a new Data Center RDMA Protocol (DCRP) layer 414. Thus for Ethernet operations the layer stack is then Ethernet layer 400, MAC layer 402, IP layer 404, DRCP layer 414, DDP layer 410 and RDMA layer 412. Also shown is an alternative Fibre Channel path which commences at Fibre Channel layer 416 first, proceeds to an IPFC layer 418 and then to IP layer 404, DRCP layer 414, DDP layer 410 and RDMA layer 412.

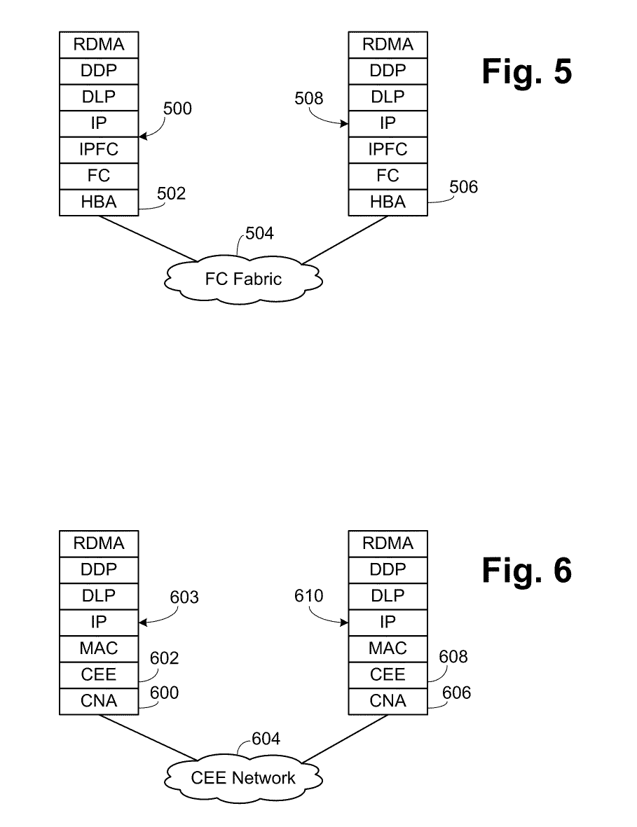

FIG. 5 illustrates the various stacks involved in an exemplary network in a Fibre Channel example. A first or host RDMA stack 500 connects through HBA 502 to a Fibre Channel fabric 504 which then is connected to the target or storage device HBA 506 and its resulting RDMA stack 508. FIG. 6 illustrates equivalent Ethernet stacks according to the present invention where a CNA (Converged Network Adapter) 600 is contained in a host stack 603, connected to a CEE layer 602 and is connected to a CEE or enhanced Ethernet network 604 where it proceeds to a CNA 606 and a CEE layer 608 in a target RDMA stack 610.

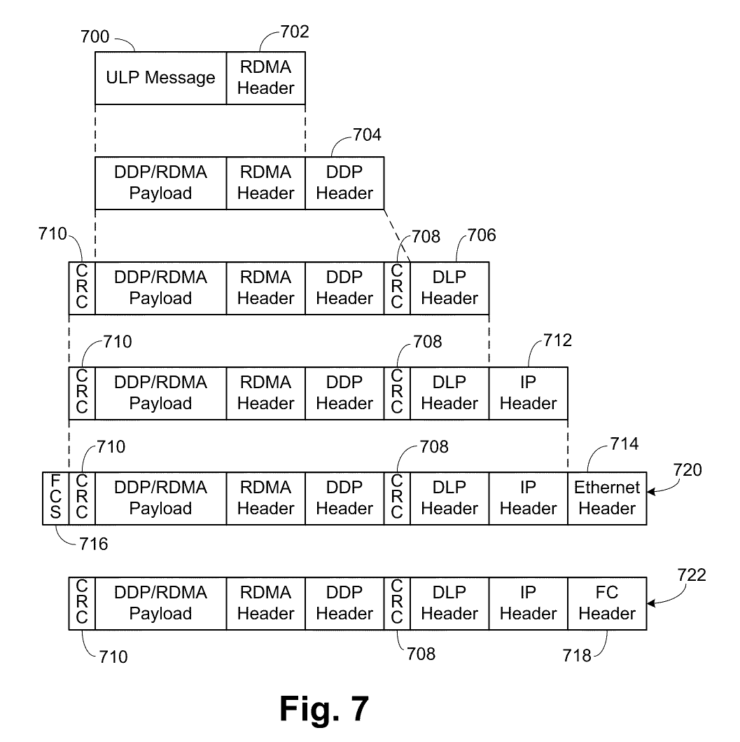

FIG. 7 shows the packet or frame format for a system according to the present invention using the DRCP layer. The packet originally starts with a ULP message 700 and an RDMA header 702. The ULP message 700 can be a command or data as normal in RDMAP. When the packet is in the DDP layer, a DDP header 704 is added to the packet. As the packet then enters the DRCP layer, a DRCP header 706 is provided, a header CRC 708 is provided after the DRCP header 706 and a frame CRC 710 is added at the end of the packet. As the packet enters the IP layer, an IP header 712 is added and the appropriate CRC 708 or CRC 710 is recalculated. The header CRC 708 is a header CRC and thus would be updated with each new header, unless such a header is not used in IP packets, in which case the packet CRC 710 would be updated. For the preferred embodiment the header CRC 708 covers the DDP header 704, the DRCP header 706 and the IP pseudo-header 712. Upon entering the MAC layer, an Ethernet header 714 is added, the CRC 710 is recalculated and an FCS (Frame Check Sequence) block 716 is added, as conventional in Ethernet. Thus the final Ethernet packet is packet 720. Shown at the bottom of FIG. 7 is an alternative Fibre Channel packet 722. An FC header 716 has been added and the CRC 710 is updated.

With that explanation, more detail of the DRCP layer is provided here. From a service user perspective, there is no difference between for an application when running over DRCP (over CEE) or over TCP with MPA. However the transport is greatly simplified as discussed below.

The preferred DRCP layer provides several advantages. The Protocol header is optimized for use with the DRCP layer. The context size is optimized for the DRCP layer and is significantly smaller than the TCP context. There will be no confusion with prior art usage which can cause issues due to the direct data placement feature. Typically for TCP or UDP, there is always the option of using unassigned port numbers for an application. When a packet is received, it is not entirely clear whether the packet is a candidate for direct data placement or not. This is resolved with the DRCP layer. There are no implementation issues in cases such as starting in streaming mode and switching to MPA mode as is true for iWARP over TCP

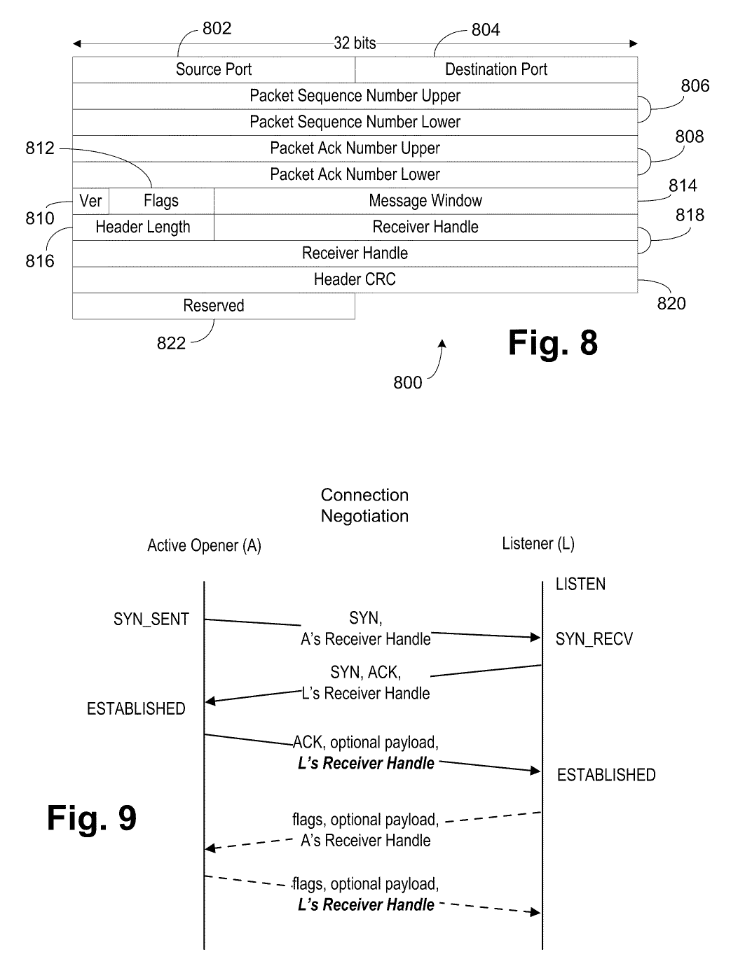

FIG. 8 illustrates a DRCP header 800 in detail. A Source Port 802 and Destination Port 804 serve the same purpose as in TCP and UDP protocols of identifying the socket to which the applications at the two ends are attached. A 64-bit Packet Sequence Number 806 identifies the packet containing data in a sequence of packets. Packets with the SYN flag and the FIN flag turned on are considered to be data packets for this purpose even if they do not contain any payload information. This concept is similar to TCP which assigns a sequence number to SYN and FIN. A 64-bit Packet Acknowledgement Number 808 indicates the next packet expected. In other words, it is one greater than the packet being acknowledged. A Version Field (2 bits) 810 has value of 0 to indicate the first version described here. The Flags 812 (6 bits) are defined as follows. A SYN Flag is used in a manner similar to the SYN flag in TCP during the connection set-up phase. If a packet has the SYN flag set, there must be no upper layer payload. A FIN Flag is used in a manner similar to TCP to gracefully terminate a connection. A RST Flag is used in a manner similar to TCP to abruptly terminate a connection An ACK Flag indicates that the Packet Acknowledgement Number field is valid. ACKs must be at message boundaries only. An ACK Requested Flag requests the receiver to send an acknowledgement. This bit can be used on the last packet of an untagged message, on the last packet of a RDMA read response, or on the last packet of an RDMA write request if an acknowledgement is required, which would not be the case if the RDMA write is followed by an untagged message. A NACK Flag indicates that the receiver has detected an out-of-order packet. The expected packet should have the sequence number equal to the sequence number in the Packet Acknowledgement Number. A Message Window 814 indicates the number of ACK requests that can be outstanding beyond those that have already been acknowledged. A Header Length 816 indicates the total length of the header in words that is covered by the header CRC 708. This includes the IP pseudo-header used in the calculation. A Receiver Handle 818 is used during the connection establishment phase (identified by packets with the SYN flag set). Each end sends its own receiver handle to the other end. During the data transfer phase (those packets on which the SYN flags is not set), every packet sent by one end contains the receiver handle provided by the other end. A Header CRC 820 uses the same algorithm as used for MPA and covers the DRCP header, the IP pseudo-header and the DDP header. This enables validation of the headers, and subsequent placement of data without validating the Ethernet CRC or the payload CRC. It reduces the latency for large packets significantly. There is no Length Field in the preferred embodiment. Assuming that the layer 3 or L3 header indicates the size of the layer 4 or L4 PDU and thereby the size of the L4 payload, there is no need for an additional length field. If needed, the reserved field 882 can be used for length. The reserved field also provides an offset for the end of the Header is present. DDP/RDMA headers have been defined in such a manner that this offset provides the proper alignment. A Data CRC is not shown because it is at the end of the payload.

In certain embodiments, RDMA Read Requests and/or RDMA Read Responses participate in the same sequence numbering as the other types of packets. Practically speaking, RDMA Read Responses do not require sequence numbers if somehow they can be associated with the corresponding request (an additional requirement is that packets of a response are transmitted with increasing offset). In certain embodiments the RDMA Read Requests are numbered like any other packets, but the response packets carry the sequence number of the RDMA Read Request packet; and are also identified through a special flag in the header. A missing RDMA read response packet can be easily detected in this case through a combination of response time-out and incorrect offset value.

These embodiments shift some of the implementation burden from the transmitter to the receiver. If the implementation of RDMA Read response is done inside the RNIC instead of the driver; the RNIC does not have to change the sequence number order from the order known to the driver.

As known to those skilled in the art CEE, formed by the combination of the Priority-Based Flow Control, IEEE P802.1Qbb; Enhanced Transmission Selection, IEEE P802.1Qaz; and Congestion Notification, IEEE P802.1Qau projects of IEEE, provides a near-lossless layer 2 transport that also provides congestion management. This makes it possible to provide a reliable transport with a relatively simple protocol.

In the background some of the complications with the existing protocol were described. Table 1 below describes how those complications are mitigated with DRCP.

TABLE 1

| | |
|---|---|
| TCP is a byte-stream oriented whereas DDP | DRCP aligns transport segments to Ethernet |
| requires the transport layer to preserve | packets. |
| segment boundaries. This requires the | If IP Header is used, the DF (Do not |
| addition of the MPA layer. In addition, it | Fragment) bit is set. |
| requires buffering for, and detection/handling | On the receive side, fragmented packets |
| of, partial PDUs | are not processed. |
| | Path MTU is discovered during the |
| | connection establishment phase only. |
| | It is assumed that the outbound and |
| | inbound paths have the same MTU |
| | Path MTU change is not a recoverable |
| | hazard |
| | There is no need for partial PDU detection and |
| | handling. This is similar to the behavior being |
| | accepted for FCoE. |
| One of the mechanisms used by MPA for | There is no need for markers |
| frame recovery is markers. Markers are | |
| inserted relative to the initial sequence | |
| number of the TCP connection i.e. to detect | |
| the location of a marker in a TCP segment, | |
| the TCP context is required. | |
| MPA marker insertion and deletion itself adds | There is no need for markers. |
| additional requirements. One example is | Path MTU change is not supported |
| when retransmitting segments when path | |
| MTU has changed. | |
| TCP context lookup requires specialized | The receiver handle provides the receiver of a |
| hardware support. This is because the TCP | packet a manner to simplify the context |
| context is identified by a sparsely populated, | lookup. As an example, if an adapter supports |
| long 4-tuple <source IP address, destination | 64K connections, it could use the lower 16 bits |
| IP address, source port, destination port) | of the receiver handle as an index into a |
| whose size in ipv6 is practically | context table. After retrieving the context, it |
| unmanageable. There are two classic ways of | can validate the port numbers and addresses. |
| doing the lookup. One is the use of Context | |
| Addressable Memory (CAM) which is very | |
| expensive in terms of silicon size and does | |
| not scale easily to the number of connections | |
| (64K or more) required for some applications. | |
| The other mechanism to use hash lists which | |
| are not deterministic in nature from a | |
| performance perspective. | |
| TCP state machine processing creates an | DRCP does not implement congestion |
| inter-dependence between the receive path | management, and depends on CEE for this |
| and the send path. This is due to the “ACK | feature. As such there is no ACK clocking. |
| clocking” and window updates of the TCP | ACKs are used only for the purpose for reliable |
| protocol. | transmission and are at message boundaries as |
| | needed. A sender can queue up all of the data |
| | it is allowed to send on the Send Queue, which |
| | presumably is very large in byte count - since |
| | the window count is in messages and very |
| | large windows can be opened. ACKs received |
| | from the remote end enable the transport layer |
| | to indicate send completion to the layer above. |
| TCP processing requires double traversal of | This issue certainly falls more in the |
| the send queue. The first traversal is to send | implementation issue category, and the work |
| the data, and the second traversal is to be able | mentioned could be done by the driver at some |
| to signal completion to the host. In theory, | cost. |
| whenever a new sequence number is | With CEE and DRCP, retransmission is |
| acknowledged by the remote peer, the second | considered a rare event. DRCP requires |
| queue must be traversed to determine the | retransmission of all of the data from the point |
| point to which completions for work requests | of loss/out-of-order detection. |
| can be signaled to the host driver. | As such, the NIC does not have to be |
| | optimized for retransmission, and any |
| | retransmissions can be handled by the host |
| | driver. |
| The TCP state machine includes many timers | This is a combination of protocol issue and |
| that have to be tracked such as delayed ACK | implementation detail. |
| timer, retransmission timer, persist timer, | In TCP, timers are in the data path because of |
| keep-alive timer and 2MSL timer. Even if the | the role they play in congestion management |
| TCP context which is fairly large is kept | (delayed ACKs for every 2 packets), |
| elsewhere, the “data-path” timers for every | retransmission/recovery, protection against |
| connection must be accessed relatively | wrapped sequence numbers (due to 32 bit |
| frequently by the device. This adds cost in | sequence number). |
| terms of on-chip memory, or attached SRAM, | However DRCP eliminates the need for TCP |
| or consumes pci bandwidth. | timers in the data path |
| | 64-bit sequence numbers eliminate the |
| | need for time-stamp option for |
| | detection of wrapped sequence numbers |
| | sending ACKs relatively infrequently, |
| | and at message boundaries, allows |
| | alternative implementations of delayed |
| | ACK timer that are not in the data path |
| | retransmission timeout is also coarse |
| | grained, and does not have to depend |
| | on accurate Round Trip Time |
| | measurement. This is because |
| | the Minimum retransmission |
| | timeout of 1 sec for TCP is |
| | probably an upper bound of the |
| | timeout for CEE |
| | If the outbound queue for a |
| | connection is not drained, there |
| | is no need to run retransmission |
| | algorithms at the sender |
| | since retransmission is |
| | infrequent and requires |
| | retransmission of all the data |
| | from point of loss, it can be |
| | managed in the host driver |
| The standard allows for multiple frames in a | This is not a feature of DRCP |
| single TCP segment. In other words, the | |
| upper layer state machine may have to be | |
| applied multiple times to the same TCP | |
| segment. | |
| Out-of-order placement and in-order delivery | Since retransmission requires retransmission of |
| requires the device to track holes in the TCP | all the packets from the point of loss/out-of- |
| byte stream, and track actions that have been | order, there is no requirement for complexity |
| deferred and must be performed when the | associated with out-of-order placement and in- |
| holes are filled. This adds significant | order delivery. |
| complexity in the processing stream, and | |
| additional storage requirements. | |
| | Most communication is dominated by one side |
| | of a connection doing more sends than the |
| | other side, at least when measured over short |
| | periods of time. This means that there are a lot |
| | of pure ACK packets. These consume both |
| | network and processing bandwidth. |
| | In traditional TCP, an ACK is sent for every 2 |
| | data packets. |
| | In DRCP, ACKs are at message boundaries, |
| | and can be heavily coalesced, since they are |
| | only used for end to end acknowledgement of |
| | data; and not for congestion management and |
| | filling the network pipe. |
| | Elimination of TCP checksum significantly |
| | reduces latency for large packets on the |
| | outbound path. |
| | Addition of Header CRC reduces latency for |
| | large packets on the receive path. |
| | The combination should minimize the |
| | significant increase in latency that one |
| | typically sees with increase in packet size |

DRCP is connection oriented since DDP as defined requires a connection oriented protocol. The connection state is relatively small and is described fully later.

The source and destination IP addresses and the source and destination port numbers identify the two end-points of a connection uniquely.

DRCP supports a simplified connection establishment model as compared to regular TCP. One end of the connection, as defined by the protocol running on top of the transport, must be an active opener of the connection, and the other end must be the listener or a passive opener. Typically the listener will wait for connection requests on the well-defined port number for an upper layer protocol. The well-defined port number is preferably assigned by the appropriate standards organization. And the active opener will use as its source port number a unused dynamic port number that is not part of the well-defined port numbers for any ULPs. Therefore the problem of simultaneous open is avoided.

FIG. 9 is a ladder diagram of DRCP operations. The active opener sets up the fields of the header as follows. There must not be any payload. The destination port number is the “well-known” port number of the peer and the local port number is assigned in a manner so that the connection can be uniquely identified. The Sequence Number is called the initial sequence number (ISN). The Sequence number should be selected in a manner that minimizes confusion with delayed packets in the network. This is the ISN for the active opener end of the connection. Acknowledgement Number is invalid since no packet is being acknowledged. Only the SYN flag is set at this point. The Message Window is a value picked by the active opener. It should typically be a large value. Receive Handle (64-bits) is the receiver handle of the active opener and is selected by local means.

The Listener, upon receiving the packet, may decide to accept, reject or ignore the packet. If it decides to accept the packet, it sets up the fields as follows (there must not be any payload). The source and destination ports are reversed from the packet sent by the active opener. The Sequence Number is also called the Initial Sequence Number (ISN). The Sequence number should be selected in a manner that minimizes confusion with delayed packets in the network. This is called the ISN for listener end of the connection. Acknowledgement Number is set to one greater than the Sequence Number in the packet received from the active opener. The SYN and ACK flags are set. The Message Window is a value picked by the listener. It should typically be a large value. Receive Handle (64-bits) is the receiver handle of the listener and is selected by local means.

The Active Opener, upon receiving the packet, will send an acknowledgement to the Listener. Payload may accompany the packet. The source and destination ports are the same as sent by the Active Opener in the first packet it sent to the listener. The Sequence Number depends on whether a payload is present or not. Sequence Number is incremented by one from ISN if a payload is present. Otherwise it is the same as the ISN. Acknowledgement Number is set to one greater than the Sequence Number in the packet received from the active opener. The SYN and ACK flags are set. The Message Window is a value picked by local means. Receive Handle (64-bits) is the receiver handle of the active opener as received in the packet from the listener. All subsequent packets from the active opener to the listener carry the receive handle sent by the listener for this connection.

At this point the connection is open and data can be transferred.

Reliable data transfer requires the ability to detect missing data, the ability to acknowledge received data and the ability to detect missing packets and retransmit data. CEE satisfies the first requirement of reliable transfer of data by using a unique sequence number for every packet containing data or packets in which the SYN or FIN flag is set. It is noted that numbering pure ACK or NACK packets increases the size of metadata required for retransmission because the sender not only has to keep track of sequence numbers used for data packets, it also has to keep track of sequence numbers for pure ACK/NACK packets. For this reason, the preferred embodiment numbers only packets containing data or the SYN/FIN flag.

The following is an overview of the packets that may be sent from one end to the other during the established phase of the connection. See the description on termination for a usage of the FIN and RST flags. Also see the description on handling loss of packets for usage of NACK flag.

One end of the connection may send packets containing payload to the other end. These packets may be formatted as follows. The source and destination ports usage should be as previously discussed. Since a payload is present in the packet, the sequence number is one greater than the last packet containing payload that was sent (see discussion of retransmission later). If the ACK flag is set, the Acknowledgement Number is valid. See rules for Acknowledgement and setting the ACK Sequence Number below. The Message Window is a value picked by local means. The payload consists of DDP and RDMAP protocol headers, and if required, a DDP/RDMAP payload. An entire DDP message should either consist of a single packet or which is the last packet or one or more non-last packets followed by a last packet. All packets but the last packet must be equal sized. The size (including transport layer, DDP/RDMAP headers, and payload, and trailing CRC) of all packets but the last packet must be a multiple of 4 bytes, equal to or less than the path MTU selected by the sender. The last packet may require padding for the CRC, done using the pad bytes in the header. The ability to send payload packets is governed by the Window Size. The message sequence number must lie in the Window advertised by the sender.

The receiver must acknowledge receipt of data by sending acknowledgements to the sender. The acknowledgement may be piggy-backed onto a packet containing payload, or it may be sent on a pure ACK packet (that does not contain any ULP payload). The following are some points for sending acknowledgements. An acknowledgement is sent when the ACK flag is set. The Acknowledgement Number is set to one greater than the sequence number being acknowledged. All packets prior to the sequence number being acknowledged are implicitly acked. The ACK flag will be set in most packets. The value of the Acknowledgement Number may or may not change from packet to packet. The Acknowledgement Number is always increasing (using modulo 2**64 arithmetic). The Acknowledgement is at message boundaries. In other words, the acknowledgement number will always be one greater than the sequence number corresponding to the end of a message. The receiver may send the acknowledgement as part of a data packet, or it may send acknowledgement in a packet that does not contain data. The former is called a piggy-backed ACK and the latter is called a pure ACK. The receiver may coalesce ACKs, i.e., not send an ACK for every message received. The receiver can use a timer of 200 milliseconds or other configurable value to send an acknowledgement. The receiver also should be aware of the outstanding Message Window it has advertised to determine when to send an acknowledgement. The sender may request that acknowledgement be expedited by setting the “ACK Requested” flag. The flag may be set in any of the packets but is meaningful only in the last packet of a message. The receiver should try to honor this request and send an acknowledgement. Excessive use of the flag is discouraged. Its primary purpose is to trigger an ACK under the following conditions. When the sender is sending large messages to this receiver and would like to free memory relatively quickly or when the sender has sent a large number of messages to this receiver.

It is expected that DRCP will run over CEE with pause enabled for the priority used to transmit this protocol. As such, it is expected that packet loss is an extremely infrequent events, with the following two being the primary reason for lost/dropped/out-of-order packets: A link/route flap due to failure or additions of equipment and rare cases of link transmission error.

DRCP must handle these conditions reasonably well. It must not require a connection reset in these conditions. It must be able to recover the missing data packets.

Since packet loss or out of order is considered an infrequent event, it is considered acceptable to retransmit all of the data from the point where missing or out of order segments are detected.

The following sub-sections analyze some of the common scenarios. The first scenario is focused on the case when the packets that are misplaced in a sequence. This is the most likely scenario as well. The case where multiple non-contiguous packets are lost should be uncommon and is discussed later. Let us consider the following scenario. Message M is in transmission. One or more packets for message M are lost or out-of-order. The trailing packets of message M are received. The receiver will detect that some packets are out of order. The receiver will send a NACK to the sender. The NACK Acknowledgement Sequence Number contains the sequence number of the next packet that was expected. If the missing packets are lost, the recovery is fairly straightforward. The peer will retransmit all of the byte stream from the point of the first detected missing segment (see later driver action). Everything works as normal from the point of retransmission. If the missing segments were out of order, things get more complicated. Essentially, all of the packets will be seen twice, but the problem is solved by discarding duplicate packets. Let us assume that the proper stream is made up of 4 chunks—A, B, C and D each following the other in order. In other words the Starting sequence number of B is the ending sequence number of A and so on. Let us say the stream got reordered as A, C, B, D. The receiver detects the A to C jump and sends a NACK to the sender. The sender retransmits B and beyond that. The original and retransmitted stream are A, C, B, D, B, C, D, E, F. The receiver detects the B to D jump and sends a NACK to the sender. The host requests the peer to retransmit from C onwards. The original and retransmitted streams are A, C, B, D, B, C, D, E, F, C, D, E, F, G. This situation must be avoided by one of two ways. The receiver avoids sending a NACK for some time after sending one. The receiver sends a NACK but the sender avoids retransmission with the knowledge that it has sent D twice. A double loss will be recovered due to the sender's timer-based algorithm.

The scenario of the loss of trailing data packets is detected by the transmitter, as it does not receive ACKs from the peer. The standard TCP method of retransmitting the first un-acknowledged packet does not work. This is because the protocol expects acknowledgement on message boundaries, and duplicate packets will be silently dropped by the device.

The preferred option is to transmit a pure-ACK packet that does not advance either the ACK sequence number or the window. If these values do have to be advanced, the sender can send two pure-ACK packets; one that advances the ACK sequence number and/or the window, and the second one that is an exact replica of the first.

The receiver on noticing a pure-ACK packet that does not advance either the ACK sequence number or the window, will generate a pure-ACK that acknowledges the last complete message received. This enables the sender to determine the message that was lost, and it can retransmit from that point onwards. It does waste an additional one RTT, but this is likely to be small compared to the total detection time.

Consider the case of a pure-ACK packet that is received out of order or is lost. A pure-ACK packet carries a sequence number that is the same as that of the last packet with payload. If the receiver detects that the sequence number has jumped unexpected, the behavior should be the same as in the case of detection of out of order packets described previously. The receiver should be aware that it can receive two pure-ACK packets that get out of order with respect to each other. In other words, the receiver will see that a pure-ACK packet acknowledges a sequence number higher than that acknowledged by a pure-ACK packet that follows immediately after. The latter packet should be ignored. The receiver may see a pure ACK packet with a sequence number lower than that of the preceding data packet (accounting for modulo 2**64-1). In such a case, the receiver can either discard the pure ACK packet or go into a mode similar to that of out of order packets. Either behavior should provide proper recovery. A pure-ACK packet may be lost in the middle somewhere. Typically the subsequent data packet will provide the acknowledgement sequence number and window update as required. No recovery action will be needed. A trailing pure-ACK packet may be lost. The recovery in this case will be similar to the previously described “trailing packet lost” scenario.

DRCP utilizes concepts of Message Windows and Window Updates. This is somewhat similar to the concept in TCP, but different. The size of the Window is not in terms of bytes or packets, but in terms of messages. The reason for this is that a host resource is consumed when a message is sent. Each untagged message consumes a single work item from the receive queue. Each tagged message requires an acknowledgement, and thereby may consume a resource at the receiver.

The size of the Message Window is fairly large and the advertised window should be large enough such that the RNIC does not have to create an interlock between the send path and the receive path. If the advertised window is large, the host driver can queue a significant number of requests on the Send Queue to the extent allowed by the Window. As the Window is extended, the driver can observe the value from completion and queue any additional items on the Send Queue.

Finally, if an application protocol is designed in a manner such that flow control at the DRCP level is not required, an extremely large windows (16 million messages) can be advertised at all times.

Window updates will typically piggyback packets with payload or pure-ACK packets that advance the acknowledgement sequence number. However, there may be a need to send window updates on packets that are pure-ACK packets that do not otherwise update the acknowledgement sequence number. This may happen when there is a resource constraint at the receiver, and it does not wish to receive additional messages.

Only one scenario has to be considered as an exception. That is of a trailing window update in a pure-ACK packet that does not increment the acknowledgement sequence number. Such a scenario should be treated like the “trailing packet lost” scenario discussed earlier.

Connection termination is modeled after TCP. There are two ways to close a connection. Typically the connection should be shut down gracefully. This is accomplished by using a segment with the FIN flag set. A packet with the FIN flag set must not carry any payload information or have the SYN or the RST flag set. It is assigned a unique packet sequence number unlike pure-ACK packets, i.e., it carries a sequence number one larger than the last packet carrying payload. If one end sends a FIN to the other, it can only send pure-ACK packets after that unless the packets are required for retransmission. A half-close condition of the connection is supported. Simultaneous close is supported. A connection is closed when both ends have sent a FIN to each other and sent acknowledgements for the FIN packets. Acknowledgement for the FIN packet may be piggybacked on a non-FIN or a FIN packet. If a connection cannot be closed gracefully due to an error condition, one end can send a packet with the RST flag set. This must be done on a packet that does not contain a payload. An acknowledgement is not expected from the other end.

The following timers are used for DRCP:

1) Delayed ACK timer, probably with the same value as is used in TCP of 200 msecs;

2) Retransmission/persist timer with a fixed value of 1 sec and the Send Queue being drained;

3) 2MSL for TIME WAIT state is the timer used in TCP by the end that sent the last FIN, i.e., did not receive an acknowledgement for the FIN, before reusing the 4-tuple for the connection. A timer similar to this is used but the value should be more realistic than that in TCP. It should be a multiple of the maximum lifetime of a packet in a CEE network, probably a minute should be sufficient. When this timer is running, no other timers are running for this connection; and

4) Optional keep-alive timer. Locally determined value greater than 60 minutes is preferred. Used when the keep-alive timer is running, none of the other timers is running for this connection.

The following is a re-iteration of some of the requirements from layer 2. DRCP is defined for use over CEE links only. The entire path from one end-point to the other end-point should be a CEE link. The following requirements are also end to end. The priority/priorities assigned to DRCP must have Priority Flow Control enabled. ETS must be enabled. Congestion Management must be enabled. The two end-points of the connection should support outbound scheduling at the granularity of a connection specific Send Queue. It is desirable to restrict CEE to a single subnet, at least in its initial deployments. There is one way to restrict it by protocol and that is to use a specific ether-type, though that is optional. By practice, it can be done by setting the TTL bit in the IP header (if used) to 1 and by ensuring that the source and destination are on the same subnet.

Therefore a new transport layer for use with RDMA operations is provided. The new layer, termed DRCP, overcomes many of the difficulties of the use of TCP and MDA as in iWARP. This occurs in part because the DRCP layer is intended for use in a CEE-compliant Ethernet network. DRCP then handles the transport layer functions while also smoothly and simply interfacing between the requirements of RDMAP and DDP and IP. The DRCP layer is defined to allow simple and high performance operation so that a converged Ethernet environment becomes feasible and practical.

While certain exemplary embodiments have been described in details and shown in the accompanying drawings, it is to be understood that such embodiments are merely illustrative of and not devised without departing from the basic scope thereof, which is determined by the claims that follow.

What is claimed is:

1. A communication device comprising:
a device central processing unit (CPU);
device memory;
an interconnect coupled to said device CPU and said device memory;
an interface card coupled to said interconnect, said interface card including:
an interconnect interface;
a card CPU;
card memory; and
a network interface for connection to a substantially lossless network,
wherein said card CPU, is coupled to said interconnect interface, said network interface and said card memory, and said card memory is coupled to said interconnect interface and said network interface; and
software contained in said device memory for execution by said device CPU and in said card memory for execution by said card CPU,
wherein said network interface, said card CPU and said device CPU interact to provide a multilayer remote direct memory access (RDMA) stack, the stack including conventional IP, DDP and RDMAP layers and a transport layer between the IP and DDP layers which provides in-order delivery of packets and requires retransmission for out-of-order or lost packets.

2. The communication device of claim 1, wherein said transport layer utilizes a packet header fields including:
source port;
destination port;
packet sequence number;
packet acknowledgement number;
flags; and
receiver handle.

3. The communication device of claim 2, wherein said packet header fields further include:
message window;
header length; and
header CRC.

4. The communication device of claim 2, wherein said flags include:
a SYN flag;
a FIN flag;
a RST flag;
an ACK flag;
an ACK Requested flag; and
a NACK flag.

5. The communication device of claim 1, wherein the communication device is a host.

6. The communication device of claim 1, wherein the communication device is a storage unit.

7. The communication device of claim 1, wherein said interface card and said network interface are configured to operate with a Fibre Channel network.

8. The communication device of claim 1, wherein said interface card and said network interface are configured to operate with an Ethernet network.

9. The communication device of claim 8, wherein the Ethernet network utilizes priority-based flow control, enhanced transmission selection and congestion notification capabilities.

10. A communication method comprising:
providing a communication device with a multilayer remote direct memory access (RDMA) stack, the stack including conventional IP, DDP and RDMAP layers and a transport layer between the IP and DDP layers which provides in-order delivery of packets and requires retransmission for out-of-order or lost packets;
operating the RDMA stack to allow RDMA operations over a substantially lossless network.

11. The communication method of claim 10, wherein said transport layer utilizes a packet header fields including:
source port;
destination port;
packet sequence number;
packet acknowledgement number;
flags; and
receiver handle.

12. The communication method of claim 11, wherein said packet header fields further include:
message window;
header length; and
header CRC.

13. The communication method of claim 11, wherein said flags include:
a SYN flag;
a FIN flag;
a RST flag;
an ACK flag;
an ACK Requested flag; and
a NACK flag.

14. The communication method of claim 10, wherein the substantially lossless network is a Fibre Channel network.

15. The communication method of claim 10, wherein the substantially lossless network is an Ethernet network.

16. The communication method of claim 15, wherein the Ethernet network utilizes priority-based flow control, enhanced transmission selection and congestion notification capabilities.

17. A network communication layer comprising:
a transport layer which interacts with conventional IP, DDP and RDMAP layers and which provides in-order delivery of packets and requires retransmission for out-of-order or lost packets, the transport layer for use with a substantially lossless network.

18. The network communication layer of claim 17, wherein said transport layer utilizes a packet header fields including:
source port;
destination port;
packet sequence number;
packet acknowledgement number;
flags; and
receiver handle.

19. The network communication layer of claim 18, wherein said packet header fields further include:
message window;
header length; and
header CRC.

20. The network communication layer of claim 18, wherein said flags include:
a SYN flag;
a FIN flag;
a RST flag;
an ACK flag;
an ACK Requested flag; and
a NACK flag.

21. The network communication layer of claim 17, wherein the substantially lossless network is a Fibre Channel network.

22. The network communication layer of claim 17, wherein the substantially lossless network is an Ethernet network.

23. The network communication layer of claim 22, wherein the Ethernet network utilizes priority-based flow control, enhanced transmission selection and congestion notification capabilities.
